(19) United States
(12) Patent Application Publication
(10) Pub. No.: US 2008/0141761 A1
(43) Pub. Date: Jun. 19, 2008

(54) Flood and mold protection system

(76) Inventor: Paul C. Lohman, Scottsdale, AZ (US)

Correspondence Address: Paul C. Lohman, 8302 E. San Miguel Ave., Scottsdale, AZ, 85250, US

(21) Appl. No.: 11/641,139

(22) Filed: Dec. 19, 2006

(51) Int. Cl. G01M 3/08

(52) U.S. Cl. 73/49.1

(57) ABSTRACT

A containment and collection system for leakage occurring within a plumbing run is disclosed and comprises a secondary sleeve with couplers fittable onto the piping of a plumbing run. The sleeve and couplers are oriented to form a void between the piping of the plumbing run and the sleeve and the couplers, and where the void allows for the collection and retention of any leakage. The sleeves and couplers extend for the length of a plumbing run and may then be directed to a collection basin where any leakage can be accumulated. The collection basin may include a level sensor and alarm for notification of a leak event.

In an alternate embodiment, a sleeve for a containment and collection system includes a longitudinal opening or slot which can be spread to allow installation onto the piping of a plumbing run. The opening also allows visual observation for the detection and location of a leak.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to plumbing systems. More specifically, the present invention relates to plumbing runs that have a secondary containment and collection system to prevent flooding and water damage.

The advent of indoor plumbing was one of the greatest boons to the development of organized societies not only in terms of allowing the density of population centers to increase but also in terms of retarding and checking the spread of disease. Evidence of indoor plumbing dates back to the Roman Empire's usage of troughs, aqueducts and piping of fresh hot and cold water to residents, and there is evidence that cultures predating the Roman Empire also used indoor plumbing systems of various types. These early systems were typically based on brick or clay conduits, in rare cases bronze castings were used as well, for transporting water and for discharging sewerage. It wasn't until the late 1800s when iron pipe became available that the use of standardized plumbing systems started to evolve. Refinements from the early days of cast and ductile iron piping resulted in today's plumbing products that fulfill almost every imaginable need that could arise.

One of the problems associated with enhancements in indoor plumbing was the need to ensure against leaks and water damage. The plumbing runs had to be competent to carry water over distances and under pressure without experiencing leaks. Quite often leaks would occur at joints or bends in the system where the fittings might not seal completely. In other instances the materials used for the pipe might corrode over time and a failure would occur at some point in the system. In any event, leaks and water flows of various kinds would be experienced. Techniques for improving the piping systems included compounds to assist in sealing joints and fittings, the use of alloys or specialized materials for the piping as well as better plumbing and fitting methods. Still, even in the face of these advances and with the technological improvements in plumbing products leaks and water damage still occur from time to time, characterized by the flooding of spaces within the building, the accumulation of leakage and the generation of molds, and other types of damage.

No matter what the source, leaks occur in plumbing systems at almost any point. Given the fact that most all plumbing systems are intentionally concealed within walls or chases, the existence of a leak is typically made known when it has already commenced to cause damage. This problem occurs equally as between residential and commercial buildings and it can be particularly troubling when the leak is located on an upper floor in a multi-floor building. The potential for damage in such a case is obviously greatly increased when there are multiple floors involved. The desire would be to identify that a leak or some kind of water damage is occurring at the earliest possible time. It would also be desirable to be able to locate the source of the leakage in some fashion.

There have been some advancements in the prior art that relate to methods for enclosing piping including U.S. Pat. No. 4,535,822 (Rogers, Jr.) where a split fitting is installable onto a pipe section using a remotely controlled apparatus. This device is directed towards the repair of broken pipelines and does not address the longstanding problems associated with leak protection and location. In U.S. Pat. No. 5,176,025 (Butts) a pipeline system with a secondary sleeve is disclosed where the sleeve provides a pathway for liquids that infiltrate or leak into or from the pipe. The sleeve is associated with a detection sensor that sends up an alarm when any of the liquid is in contact with the sensor. The containment system in this instance is limited and is meant to cause a signal to be generated so the pipeline can be shut down and repairs initiated.

A pipeline treatment is taught in U.S. Pat. No. 5,988,224 (D'Auria) where a sleeve is used over a joint or a break in a pipeline and forms seal between the pipe sections or over the break. The sleeve has a cavity between the sleeve and the pipeline and a plastic compound is injected into this cavity and caused to polymerize thus sealing the area enclosed by the sleeve. This concept does not suggest a way to contain, collect and identify the source of leaks in a piping system. Similarly, in U.S. Pat. No. 5,722,463 (Smyth, et al) a split sleeve is used to seal off a leak in a pipe. This approach does not provide a means for the collection or containment of a leak nor does it suggest the location of the leak. In U.S. Pat. No. 5,406,871 (Lambert, Jr.) an elastomeric sheath is stretched over a frangible structure that may be inserted over a wiring harness. The tube can be broken allowing the elastomeric sheath to contract sealing off the wiring harness. Although sheath does enclose the wire bundle and is held off by the frangible structure, it does not function to contain leaks in piping. Similarly, in U.S. Pat. No. 4,802,509 (Brandolf) an adjustable sheath is shown that can close off electrical conduits, and with respect to U.S. Design Pat. No. 348,723 (Carroll) a cover for insulated conduits is shown. Neither one of these prior art devices will contain and collect leakage or assist in the location of the source of a leak.

None of the prior art devices has effectively solved the problems associated with indoor plumbing systems, specifically where piping may exhibit leaks. Therefore there remains a long felt need for a solution that would contain the fluids resulting from any leakage, that would control the leakage, and lastly a solution that would assist in locating the source of the leakage. It is asserted that the present invention solves these problems and provides other benefits and attributes as will be discussed in more detail below.

### SUMMARY OF THE INVENTION

A novel containment and collection system for indoor plumbing comprises a secondary sleeve assembly fitted around and enclosing a plumbing run thereby forming a void between the secondary sleeve and the plumbing run for the containment of any leakage from the plumbing run, where the secondary sleeve assembly includes sleeves with couplers spaced along the plumbing run. The couplers include windows for visual inspection of the void area and the couplers further include standoffs to maintain the void.

In one embodiment of the present invention, the secondary sleeve assembly controls and collects the leakage from the plumbing run directing it to a collection point.

In yet another embodiment of the present invention, the secondary sleeve assembly comprises a split sleeve that includes a top portion with a longitudinal opening, and with standoffs for maintaining a void between the secondary sleeve assembly and the plumbing run.

### BRIEF DESCRIPTION OF THE DRAWINGS

FIG. 1 is an isometric diagram showing a containment and collection system of the present invention.

FIG. 2 is an isometric view of a coupler of the present invention installed onto a plumbing run.

FIG. 3 is a side cross sectional view of the sleeve, coupler and plumbing run of FIG. 1 taken along Section Lines at 3-3.

FIG. 4 is a cross section of the coupler and plumbing run of FIG. 2, looking axially along Section Lines 4-4.

FIG. 5 is an isometric view of an alternate embodiment of a sleeve of the present invention as installed on a plumbing run.

FIG. 6 is a cross section of the sleeve and plumbing run of FIG. 5, looking axially along Section Lines 6-6.

### DETAILED DESCRIPTION OF THE PREFERRED EMBODIMENTS

A containment and collection system in accordance with the present invention is shown in the drawings and is discussed in detail herein. The application of the present invention is feasible with plumbing runs of various types with only slight modifications. The first objective is to ensure that the containment of the fluids that may be leaking (potable water, waste water, grey water, etc) is sufficient to prevent damage to the building or its contents. The second objective is to collect the leakage. Collection necessarily includes a measure of control, which as will be seen, is obtained by providing a conduit or pathway for the leakage to flow in an intended manner. The last objective is to determine that there is leakage and where it is located. Not all three objectives need to be included in each application of the invention, for instance, containment may be a solitary objective, or containment and collection may be paired, or all three objectives may be combined, each of these three combinations representing segregate ways of practicing the invention.

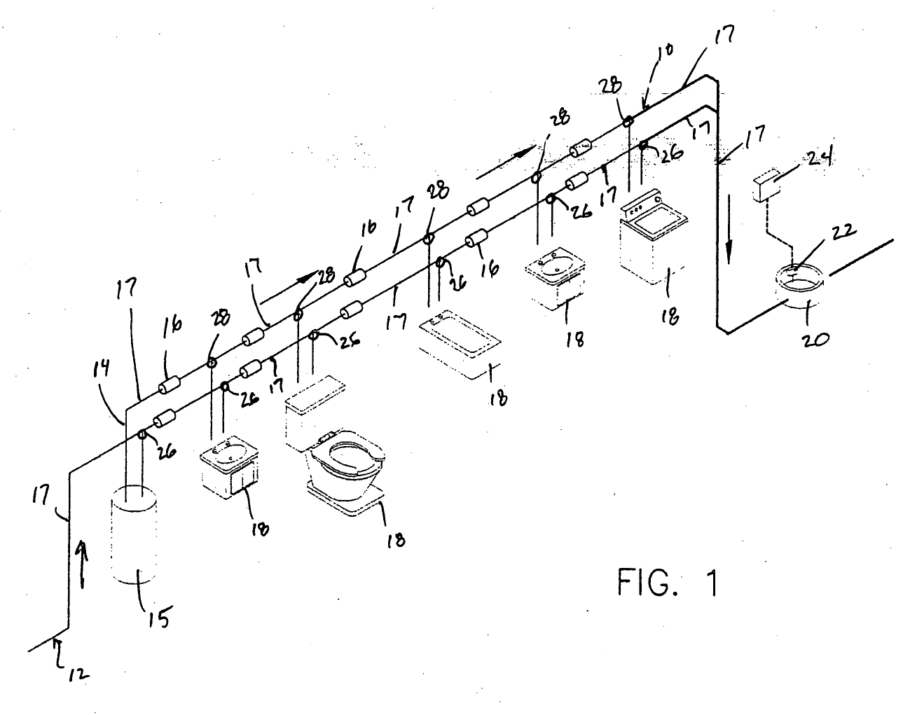

With the foregoing in mind, the containment and collection system of the present invention is diagrammatically displayed in FIG. 1, the containment and collection system 10 being shown in a general fashion and includes the cold water supply side 12, the hot water supply side 14 which commences at the hot water heater 15, couplers 16, sleeves 17, utilities 18, the collection basin 20, the level sensor 22, the alarm 24, the cold water drops 26 and the hot water drops 28.

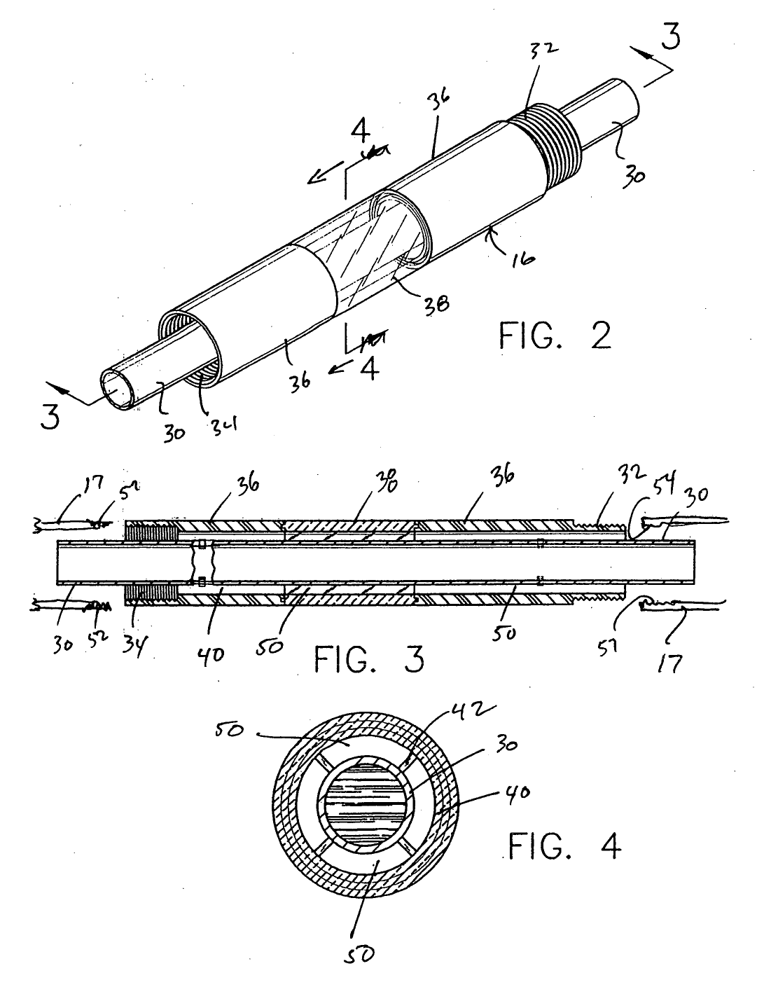

Components of the containment and collection system can be seen in the rest of the drawings, where in FIG. 2 a coupler 16 is shown enclosing a portion of a plumbing run 30, where the coupler 16 includes the male thread 32, the female thread 34, the coupler body 36 and the window 38. The same coupler 16 is seen in side cross section in FIG. 3 and in axial cross section in FIG. 4 and discloses the guide 40 with associated standoff 42, and the void 50. Also viewable in FIG. 3 are the ends of adjacent sleeves 17 with associated male threaded end 52 and female threaded end 54.

The containment and collection system of the present invention is intended to prevent the leakage from plumbing runs from generating any damage to or in the surrounding area. As may be appreciated from the drawings, the containment and collection system has two main components, the sleeves and the couplers, which fit over and enclose the typical piping found in indoor plumbing runs. In the case of the present embodiment, the containment and collection system is installed when the plumbing runs are installed. A second embodiment of the present invention will be discussed below that allows for installation of a containment and collection system on pre-existing plumbing runs. The couplers and sleeves are joined end-to-end with the couplers distributed about the system at select points. The couplers have a guide that is fixed within their interior radius and the guide has projecting standoffs that are sized to suspend a plumbing run (pipe) centrally within the coupler body as shown in FIGS. 3 and 4. As may be realized from FIG. 3, the sleeves are fittable onto the coupler, in the present case by means of threaded ends that compatible engage the corresponding threads in the coupler body, with intervals of sleeve and coupler extending along the length of the containment and collection system. The sleeves also enclose the plumbing run and by virtue of the suspension of the piping within each of the couplers the piping of the plumbing runs is held in suspension in the sleeves as well. There is formed a space, or void, between the piping of the plumbing runs and the sleeves and couplers of the containment and collection system. This void communicates throughout the length of the plumbing run and as shown in FIG. 1, it preferentially is joined and is directed to the collection basin.

As generally understood in FIG. 1, the schematic shows the containment and collection system not the plumbing runs which are enclosed therein. In fact, the plumbing runs terminate at the last utility in the direction of flow as indicated in the drawing. The plumbing runs (cold water supply and hot water supply) have periodic drops which represent points where the piping is diverted by means of an elbow or a T-fitting to a particular place of usage identified generally as a utility. At the junction of a drop, the sleeve can be modified to allow the drop to exit while keeping the sleeve sealed. For instance, a hole can be cut into the sleeve to allow the drop to exit and the hole can be sealed around the drop using an annular fitting and sealant or packing. In an alternate manner, a T-fitting or an elbow can be threadably installed on the sleeve, then the drop can be threaded into the plumbing run, and the drop can be sealed to the T-fitting or the elbow through the use of a threaded cap that has a central hole for passing the drop there-through. The actual seal can be a plastic compression type fitting or an O-ring. These techniques are well known to one skilled in the art and are not specifically a part of the present invention although they can be employed in the present embodiment. The pathway of the hot water flows in the system shown in FIG. 1 commences at the point where the cold ware drop at the hot water heater supplies cold water to it, which is then exits the hot water drop for the hot water heater and then into the hot water drops for each of the succeeding utilities on that plumbing run. As can be seen therefore, there are two containment and collection runs coinciding with the cold water supply run 12 and the hot water supply run 14.

Both of the containment and collection runs join together into a single run as they approach the collection basin. The point at which they join is a matter of selection on the part of the plumber installing each system. The benefits of the collection include the fact that the leakage is being diverted away from the interior of a building and the collection basin is typically engineered to ensure that any flows that are collected may fill the basin and then are discharged into a waste or sewer line. Technically speaking, each run, as well as runs from other containment and collection systems could be kept separate, however the dictates of economy recommend that joining the runs would be a preferred method of practicing the invention. The runs for the containment and collection system are constrained to follow the plumbing runs which may be understood, although plumbing runs are usually installed in substantially vertical or horizontal arrangements. This means that when the present invention has been deployed, and a leak in a plumbing run erupts, then the person responsible for maintaining the system can first check the collection basin to see if any flows have occurred. This happens because as the leakage is contained and collected, it will eventually get to a point where it will flow out the only path available which, as is shown in FIG. 1, leads to the collection basin. The person who inspects the collection basin then can backtrack through the system and determine at various points where flow is observed by looking through the windows in each of the couplers. To gain access to the couplers, the person may in some cases have to open up portions of a wall, although in situations like an apartment or office building, pipe galleries or chases are provided which would make inspection a matter of opening up an access door and checking the system.

The preference for a new installation would be to install the plumbing runs on a slope consistent with promoting the drainage of the containment and collection runs. For conventional drain lines, a slope equal to one foot descent over ten or twelve running feet of pipe has been typically sufficient to ensure a good flow rate, although less slope can be used with the present invention since there is no danger of clogging the system when dealing with potable water. The objective would be to ensure that the evidence of the flow is apparent both at the collection basin and through the windows in the couplers in order to minimize the time for leak detection and location.

Leak detection, which may have been assumed from the discussion regarding the person's visual observations of the windows, does occur by a process of deduction. The flow (or lack thereof) is observed in each window until the source of the leakage is isolated within the system. This allows the repair to be directed very accurately to the place where it is needed all the while the building and its contents is being protected from what would have been considerable water damage.

The usage of a level alarm is very feasible and many such alarms are available conventionally. In the case where a person is charged with the care and maintenance of a large building or complex, it would be expected that multiple collection basins would be installed. The alarms could then be remotely indicated so that leak detection for a number of buildings or offices, or apartments could be monitored from a single location.

The couplers and the sleeves are preferably threaded and are threadably engaged as well. This allows for dismantling of parts of the containment and collection system without having to cut into it. The sleeves and couplers of the present invention are preferably constructed from plastic materials owing to the low cost and light weight and availability of PVC or CPVC plumbing products. The windows in the couplers are typically plastic as well.

There is no reason preventing the use of the present invention on discharge or waste lines, although leakage is typically less prevalent since these applications are usually not under pressure. Nonetheless, any leakage from a discharge or waste line would be extremely obnoxious and containment and collection would be a very positive attribute.

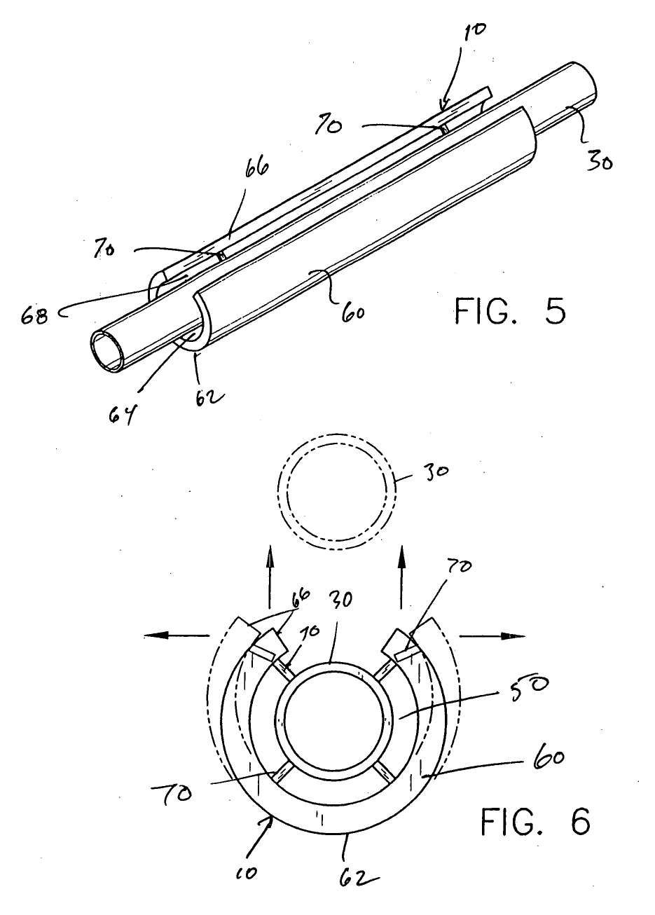

In an alternate embodiment of the present invention, and as shown in FIGS. 5 and 6, a containment and collection system 10 for use in pre-existing plumbing runs 30 is disclosed and includes a sleeve 60, with sleeve bottom 62, sleeve interior 64, sleeve top 66, top opening 68 and with standoffs 70. As can be seen in the drawings, the sleeve can be spread at the top longitudinal opening (see FIG. 6) to allow enough access to allow the sleeve to be fitted onto the piping of a plumbing run. As was the case in the previous embodiment, the sleeve has standoffs disposed about its interior in order to provide spacing for a void 50. The sleeve extends for the length of the plumbing runs and in this case there is no need for the coupler of the previous embodiment since the void area is visible by observation through the opening in the sleeve.

In use, the sleeves can be formed from section and then joined end-to-end using conventional plumbing techniques such as threads or by solvent welding. The sleeves are also sized appropriately to be able to enclose couplers on the plumbing runs or changes in the sizes of piping in the plumbing run. As was the case for the previous embodiment, the sleeve can accommodate drops at points along a run either through the cutting and sealing of holes in the bottom of the sleeve for the plumbing drop to exit, or by providing a fitting such as an elbow or T-fitting at these points and sealing the fitting where the plumbing drop exits.

The advantage of this embodiment is the fact that it can be deployed on pre-existing plumbing and still achieve the benefits and functions of the previously discussed embodiment. The containment and collection system can be routed to a collection basin and can be outfitted with level sensors and a leak alarm. Most importantly however, is the fact that the sleeves can be visually inspected and the existence and location of any leakage is easily determined all the while the building and its contents remain protected from water related damage.

The materials for the construction of this embodiment are essentially the same as for the previous embodiment to the extent the plastic is flexible enough to allow the opening to be spread. PVC and CPVC piping products are fairly rigid and especially with regards to smaller diameters do not admit to much flexibility so alternate plastic resins may have to be considered in some applications so as to impart enough flexibility to allow the sleeves to be fitted onto piping. Such plastics are known in the art and are a matter of an engineering selection.

The benefits of the present invention include the ability to contain and collect any leakage from a plumbing system. Water damage can be significant in a case where leakage occurs and is not immediately observed. The effects of water escaping from the plumbing runs can persist and can promote the incubation of molds that in themselves can become health hazards and lead to extreme measures for rehabilitation and repair. The containment and collection system is especially useful in applications where a large number of plumbing runs are in use. Office buildings, apartments, condominiums and the like would examples of buildings that would benefit from this concept. The various plumbing runs can each be monitored electronically through the use of the level sensors and alarms situated at the collection basins. The output from the sensors or the alarms can be relayed to a location, such as a maintenance office, where any evidence of leakage will be indicated in a way to inform the maintenance staff of the existence and location of the leak event. This allows an immediate reaction to the problem and avoids any unnecessary delay which could increase the amount of damage that might otherwise occur.

The present invention may be modified or varied in ways beyond those illustrated by the embodiments discussed above without departing from the spirit and scope of the concept.

I claim:

1. A containment and collection system for protecting a building from leaks in a plumbing system, the containment and collection system comprising:
A plurality of sleeves for enclosing the piping in a plumbing run, the sleeves being fittable around the piping and capable of retaining the leakage from the piping;
Couplers for compatibly engaging said sleeves in an end-to-end fashion; and,
Where said couplers include standoffs for maintaining a void between the piping and the sleeves for the collection of leakage and where said void is communicated throughout the length of the plumbing run and directs the collected leakage to a point where it is discharged.

2. The containment and collection system of claim number 1, where the couplers further include windows for the visual observation of the void.

3. The containment and collection system of claim number 1, where the leakage collected by the sleeves and couplers is directed to a collection basin.

4. The containment and collection system of claim number 3, where the collection basin is fitted with a level sensor for detecting the level of any flows that are collected, and also with an alarm for indicating the existence of leakage.

5. The containment and collection system of claim number 1, where the sleeves and couplers are constructed from a plastic.

6. A containment and collection system for protecting a building from leaks in a plumbing system, the containment and collection system comprising:
A plurality of sleeves for enclosing the piping in a plumbing run, the sleeves being fittable around the piping and capable of retaining the leakage from the piping;
Couplers for compatibly engaging said sleeves in an end-to-end fashion; and,
Standoffs for maintaining a void between the piping and the sleeves for the collection of leakage and where said void is communicated throughout the length of the plumbing run and where the sleeves and the couplers direct the collected leakage to a point where it is discharged.

7. The containment and collection system of claim number 6, where the sleeves include a top longitudinal opening which can be spread to allow access for installation onto the piping of a plumbing system, and also where the top longitudinal opening provides access for visual observation of the void.

8. The containment and collection system of claim number 6, where the point the leakage is discharged is a collection basin.

9. The containment and collection system of claim number 8, where the collection basin further includes a level sensor for detecting the accumulation of leakage.

10. The containment and collection system of claim number 9, further including an alarm to indicate leakage when the level sensor detects leakage.

11. The containment and collection system of claim number 6, where the sleeves and couplers are constructed from a plastic.

12. A containment and collection system for protecting a building from leaks in a plumbing system, the containment and collection system comprising:
A plurality of sleeves for enclosing the piping in a plumbing run, the sleeves being fittable around the piping and capable of retaining the leakage from the piping, where the sleeves include a top longitudinal opening which can be spread to allow access for installation onto the piping of a plumbing system, and also where the top longitudinal opening provides access for visual observation of the void;
Couplers for compatibly engaging said sleeves in an end-to-end fashion; and,
Standoffs for maintaining a void between the piping and the sleeves for the collection of leakage and where said void is communicated throughout the length of the plumbing run and where the sleeves and the couplers direct the collected leakage to a point where it is discharged.

13. The containment and collection system of claim number 12, where the point the leakage is discharged is a collection basin.

14. The containment and collection system of claim number 13, where the collection basin further includes a level sensor for detecting the accumulation of leakage.

15. The containment and collection system of claim number 14, further including an alarm to indicate leakage when the level sensor detects leakage.

16. The containment and collection system of claim number 12, where the sleeves and couplers are constructed from a plastic.
